(19) United States
(12) Patent Application Publication
(10) Pub. No.: US 2014/0215170 A1
(43) Pub. Date: Jul. 31, 2014

(54) Block Compression in a Key/Value Store

(71) Applicant: FUTUREWEI TECHNOLOGIES, INC., Plano, TX (US)

(72) Inventors: Anthony Scarpino, Mountain View, CA (US); John Plocher, San Jose, CA (US)

(73) Assignee: FutureWei Technologies, Inc., Plano, TX (US)

(21) Appl. No.: 13/756,038

(22) Filed: Jan. 31, 2013

(51) Int. Cl. G06F 12/16

(52) U.S. Cl. CPC G06F 12/16
USPC 711/161

(57) ABSTRACT

System and method embodiments are provided for improving the performance of data compression for storage systems. The embodiments enable selectively compressing data for storage on a block by block basis to save resources and computation time and cost. The system and method also handle the compression of different types of data blocks using different targeted algorithms. In an embodiment, a method for compressing data in a storage system includes receiving one or more data blocks for storage, determining whether to compress one or more data blocks according to attributes of the one or more data blocks, upon determining to compress a data block from the one or more data blocks, compressing the data block, and storing the compressed data block. The attributes include at least one of a name of the data block, a file type of the data block, and information in the data block.

### TECHNICAL FIELD

The present invention relates to storage technology, and, in particular embodiments, to a system and method for block compression in a key/value store.

### BACKGROUND

When the utilization of a storage system approaches 100%, more storage capacity is required to store additional data. Storage capacity can be increased by purchasing more storage units or by compressing the existing data in the system. Current solutions (such as the Voldemort Compressed Store component) compress every data block (e.g., portion or chunk) of the data content as the data is being stored. Typically, all blocks of the data to be stored are compressed using a fixed algorithm, e.g., with fixed parameters and resource usage (CPU, memory, and storage resources). The fixed algorithm is determined to achieve a compromise or tradeoff between saving storage space and reducing computation (compression/decompression) time. Compressing all data using such a fixed algorithm can lead to performance issues, such as when not all the content is a good candidate for compression. For example, some data or blocks may be already in compressed format (e.g., a .zip or .jpeg file format) which resists further compression during storage. Compressing such data wastes time and resources but does not save (and may increase) space. An improved compression scheme is needed to address such issues.

### SUMMARY OF THE INVENTION

In accordance with an embodiment, a method for compressing data in a storage system includes receiving one or more data blocks for storage, determining whether to compress one or more data blocks according to attributes of the one or more data blocks, upon determining to compress a data block from the one or more data blocks, compressing the data block, and storing the compressed data block.

In accordance with another embodiment, a network component configured for selective compression of data in a storage system includes a processor and a computer readable storage medium storing programming for execution by the processor. The programming including instructions to determine, responsive to receiving one or more data blocks for storage, whether to compress the one or more data blocks according to attributes, content, or both attributes and content of the one or more data blocks, upon determining to compress a data block from the one or more data blocks, compress the data block, and store the compressed data block.

In accordance with yet another embodiment, in a storage system, a method for selective compression of data includes obtaining a plurality of data blocks for storage, selecting at least some of the data blocks as candidates for compression according to at least one of attributes and content of the data blocks, compressing the data blocks selected as candidates for compression, storing the compressed data blocks; and storing without compression any remaining data blocks that are not selected as candidates for compression.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is an example of a data object;

FIG. 2 is an embodiment of a compression method;

FIG. 3 is a processing system that can be used to implement various embodiments.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

System and method embodiments are provided for improving the performance of data compression for storage systems. The embodiments enable selectively compressing data blocks that are to be stored, e.g., instead of unilaterally compressing the entire data (as in current storage compression systems). The provided compression scheme which selects which of the stored data blocks to be compressed can save time and resources in both compression and decompression processes. For instance, some of the blocks that are not suitable for compression can be stored and retrieved without compression and decompression, which saves resources and computation time/cost and hence improves overall system performance (e.g., in terms of space/time tradeoff). The compression scheme is also adaptive to handle the compression of different types of data blocks by using different algorithms, e.g., with variable parameters and resource usage/allocation (CPU, memory, and storage resources).

In an embodiment, the compression scheme or method is implemented in a key/value storage system that stores data in the form of data objects. Each object is composed of a key and value. The key is used to identify the data object, and the value corresponds to data content. A data object may correspond to a single data structure or set of data (e.g., a file or a folder of files). Alternatively, the data object may correspond to a block or chunk of data, such as a portion of a file or a file from a folder of files (a set of files).

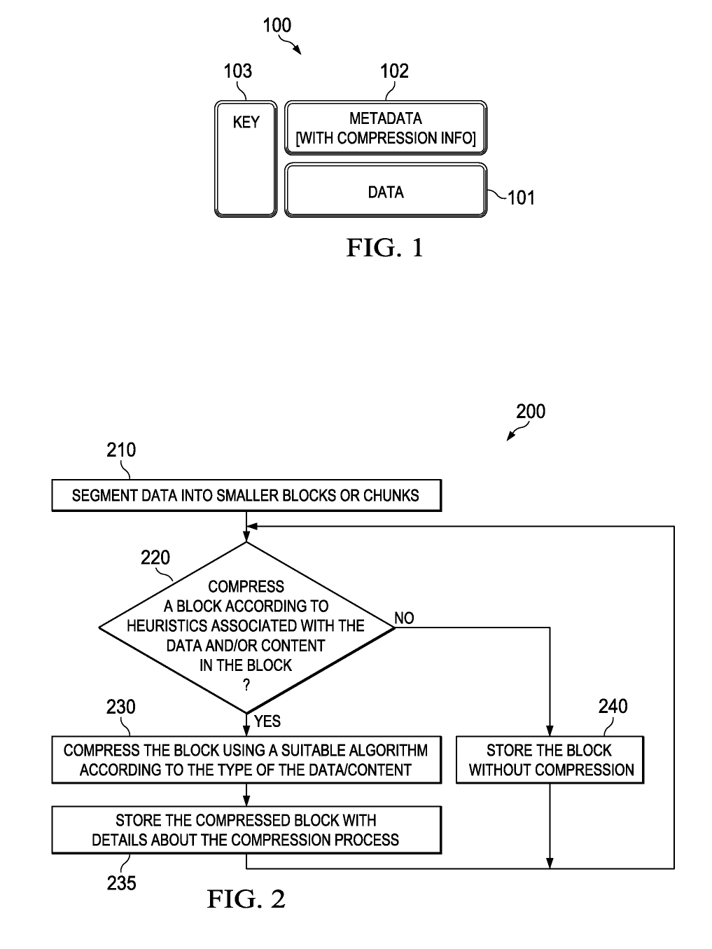

FIG. 1 shows an example of a data object 100 that can be stored on the storage system. The data object 100 is comprised of data content 101, metadata 102 that includes attributes of the data content 101, and a key 103 associated with the data content 101. The metadata 102 also includes compression information when the data content 101 is compressed for storage. The compression information is added when compressing the data (e.g., during storage) and may be used to decompress the data (e.g., during retrieval). For example, a compression algorithm adds the compression information to the metadata 102 during the compression of the data content 101. The compression information can then be used by a corresponding decompression algorithm to decompress the data content 101.

The storage system may be a localized or centralized storage system that stores any number of data objects (e.g., data objects 100), such as a hard disk, a flash memory card, a random access memory (RAM) device, and/or a universal serial bus (USB) flash drive, etc. Alternatively, the storage system may be a remote or distributed system (e.g., on one or multiple disks and/or other suitable devices) across the Internet, other network, and/or multiple data centers. The data object 100 (or data content 101) can be compressed while the data is being stored. Alternatively, the data may also be compressed after storage, for example by retrieving or reading the store both compressed and uncompressed data objects 100, e.g., at the same storage device. For example, the data content 101 in some of the stored data objects 100 can be compressed while the data content 101 in other stored data objects 100 are not compressed.

During data storing, the compression scheme can determine whether a data object being stored is or is not a good candidate for compression. The scheme can use heuristic analysis to decide whether to compress the data being stored. The analysis can include heuristics (attributes), such as the name of the data object (e.g., file or file extension name), relevant information in one or more first blocks of the object, measuring a compression ratio of the one or more first blocks, and/or other suitable combinations of heuristics. According to the analysis, files that are not good candidates for compression are not compressed, such as files that are already in compressed formats, (e.g., “mp3”, “mpeg”, “zip”, or “tar” files). Short lived data, e.g., data that is stored for relatively short time and then deleted, may also be stored without compression. Analysis of object content or content header (metadata) can also be used to determine whether to compress the object. For example, the scheme can examine the content of a file or object to identify the type of its content, such as searching for identifiers in the content to identify “pdf” or “htm” files. For relatively large objects, a first portion may be compressed to assess the resulting saving in space. Based on the compression of the first portion, the scheme can decide whether to compress the data object (e.g., if significant saving can be achieved by compressing the data object).

Good candidates resulting from the heuristic analysis can then be compressed using a selected and suitable algorithm, either inline (while data is being stored) or offline (in the background at the storage system). Different targeted algorithms can be used for different types of objects or data, for example to achieve different tradeoffs between space and computation time. Relatively large data objects may be compressed using an algorithm that saves more space at the expense of computation time, while relatively small data objects may be compressed using another algorithm that saves more computation time at the expense of space. Bad candidates can be stored with no compression. In either case, the uncompressed-on-demand content data is delivered (if needed) to the user or client whenever the block data is retrieved.

In an embodiment, a set of functions can be used in the compression scheme to handle data objects, such as a data object 100. The functions include a put command to store an object without compression. The put command can be in the form PUT (key, value), where, for example, “key” represents the key 103 and “value” represents the data content 101. The metadata is also generated and stored with the key and value. The functions also include a get command to read the stored object, such as in the form METADATA=GET(key). This command returns a structure that contains both the metadata and the object data content. The functions also include a compression command, such as in the form Metadata.setCompression (type, parameters), where “type” represents the type of the object or the type of the compression algorithm for the object, and “parameters” represent the parameters used in the compression algorithm. The compressed object can then be stored using the put command, such as PUT (key, metadata). Uncompressed data can then be retrieved using the get command, such as GET (key).

An original object can be compressed for storage using the compression command above in the background, e.g., in a manner transparent to the user or client. Similarly, a compressed objected can be decompressed to retrieve the original object in a manner transparent to the user. The user may only use the put command and the get command to store and retrieve, respectively, the object. The processes of determining whether to compress an original object for storage, compressing the original object, and decompressing a compressed object to retrieve the original object can be implemented automatically or seamlessly by the storage/compression system without the user involvement, request, or knowledge.

As described above, the compression scheme and storage system are configured to perform on-demand compression (based on heuristics and content) and specify a suitable algorithm type and details accordingly on a chunk by chunk basis of storage data. The scheme and system are also configured to remember the details of the compassion, for example by storing the details in the metadata of the object or in a related file, so that the compressed data can be automatically (without the user involvement) decompressed upon retrieval. This scheme can lower the computation cost (e.g., by compressing efficiently only the chunks or objects that are suitable for compression) and still deliver efficient compression to increase the storage capacity of the system. This scheme also enables better control of the resources of the system by selectively compressing the data and using targeted algorithm types for different types of data.

FIG. 2 shows an embodiment method 200 for compressing data objects or files (e.g., on a chunk by chunk basis) selectively according to heuristics and content and using targeted algorithms. At step 210, received data can be segmented into smaller blocks or chunks. For example, a single large files can be divided into smaller files or a folder of files can be divided into individual files. The received data can also be in the form of a data object, which is further segmented into chunks of objects. At step 220, the scheme determines whether to compress a block using heuristics (attributes) associated with the block (e.g., file type or name) and/or content in the block. Based on the analysis, if the block is found suitable for compression, then the method 200 proceeds to step 230. Otherwise, the method 200 proceeds to step 240. At step 230, the block is compressed using a suitable algorithm according to the type of the data/content. At step 235, the compressed block is stored with details about the compression process. For example, the compressed block is stored as a data object and the compression details or information is included in the metadata of the stored data object. Alternatively, at step 240, the block is stored without compression, e.g., as a data object. After blocks 230 and 240, the method 200 returns to block 220 to determine whether to compress a next block of the received data.

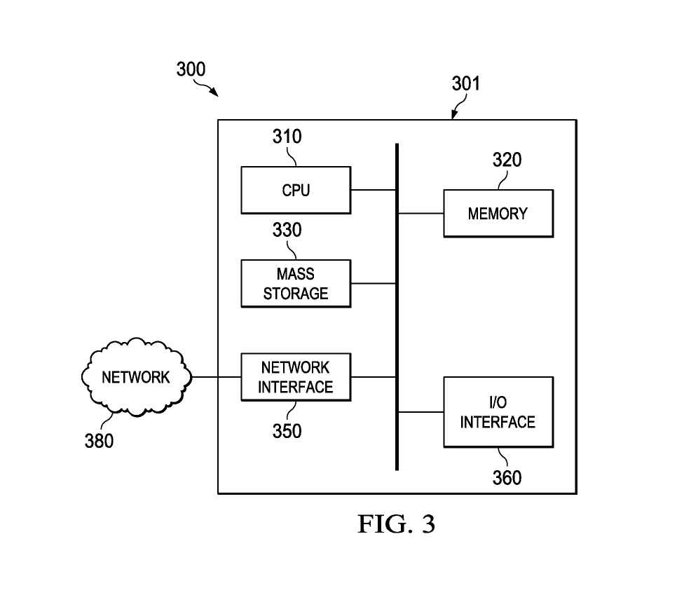

FIG. 3 is a block diagram of a processing system 300 that can be used to implement various embodiments. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system 300 may comprise a processing unit 301 equipped with one or more input/output devices, such as a network interfaces, storage interfaces, and the like. The processing unit 301 may include a central processing unit (CPU) 310, a memory 320, a mass storage device 330, and an I/O interface 360 connected to a bus. The bus may be one or more of any type of several bus architectures including a memory bus or memory controller, a peripheral busor the like.

The CPU 310 may comprise any type of electronic data processor. The memory 320 may comprise any type of system memory such as static random access memory (SRAM), dynamic random access memory (DRAM), synchronous DRAM (SDRAM), read-only memory (ROM), a combination thereof, or the like. In an embodiment, the memory 320 may include ROM for use at boot-up, and DRAM for program and data storage for use while executing programs. In embodiments, the memory 320 is non-transitory. The mass storage device 330 may comprise any type of storage device configured to store data, programs, and other information and to make the data, programs, and other information accessible via the bus. The mass storage device 330 may comprise, for example, one or more of a solid state drive, hard disk drive, a magnetic disk drive, an optical disk drive, or the like.

The processing unit 301 also includes one or more network interfaces 350, which may comprise wired links, such as an Ethernet cable or the like, and/or wireless links to access nodes or one or more networks 380. The network interface 350 allows the processing unit 301 to communicate with remote units via the networks 380. For example, the network interface 350 may provide wireless communication via one or more transmitters/transmit antennas and one or more receivers/receive antennas. In an embodiment, the processing unit 301 is coupled to a local-area network or a wide-area network for data processing and communications with remote devices, such as other processing units, the Internet, remote storage facilities, or the like.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for compressing data for storage in a storage system, the method comprising:
receiving one or more data blocks for storage;
determining whether to compress one or more data blocks according to attributes of the one or more data blocks;
upon determining to compress a data block from the one or more data blocks, compressing the data block; and
storing the compressed data block.

2. The method of claim 1 further comprising upon determining not to compress a second data block from the one or more data blocks, storing the second data block without compression.

3. The method of claim 1 further comprising:
receiving, from a client, data content for storage; and
dividing the data into a plurality of data blocks.

4. The method of claim 1 further comprising:
selecting a compression algorithm according to a type of the data block; and
compressing the data block using the selected algorithm.

5. The method of claim 4, wherein the compressed data block is stored as a data object including a key, metadata, and data content.

6. The method of claim 4, wherein selecting a compression algorithm according to a type of the data block comprises selecting an algorithm that saves more space at expense of computation time for relatively large data objects, and selecting an algorithm that saves more computation time at expense of space for relatively small data objects.

7. The method of claim 1 further comprising storing with the compressed data block compression information for decompressing the compressed data block.

8. The method of claim 7, further comprising decompressing the compressed data block using the compression information to retrieve the data block.

9. The method of claim 8, wherein the compression information is used to select a suitable algorithm to decompress the compressed data block.

10. The method of claim 1, wherein the data block is compressed automatically without a request from the client.

11. The method of claim 1, wherein the data block is compressed without knowledge of the client.

12. The method of claim 1, wherein determining whether to compress the data block includes measuring a compression ratio of the data block, and compressing the data block if the measured ratio indicates significant space saving.

13. The method of claim 1, wherein determining whether to compress one or more data blocks according to attributes of the one or more data blocks comprises examining content of the data block to determine whether to compress the data block.

14. The method of claim 1, wherein the attributes include at least one of a name of the data block, a file type of the data block, a compression ratio of the data block, and other information in or about the data block.

15. A network component configured for selective compression of data in a storage system, the network component comprising:
a processor; and
a computer readable storage medium storing programming for execution by the processor, the programming including instructions to:
determine, responsive to receiving one or more data blocks for storage, whether to compress the one or more data blocks according to attributes, content, or both attributes and content of the one or more data blocks;
upon determining to compress a data block from the one or more data blocks, compress the data block; and
store the compressed data block.

16. The network component of claim 15, wherein the programming includes further instructions to, upon determining not to compress a second data block from the one or more data blocks, store the second data block without compression.

17. The network component of claim 16, wherein the second data block stored without compression includes data already in a standard file compression format.

18. The network component of claim 16, wherein the second data block stored without compression includes relatively short lived data that is temporarily stored.

19. The network component of claim 15, wherein the data block is part of a single data structure or a single set of data.

20. The network component of claim 15, wherein the programming includes further instructions to:
select a compression algorithm according to a type of the data block; and
compress the data block using the selected algorithm and a plurality of parameters to configure the algorithm.

21. The network component of claim 15, wherein the attributes includes at least one of a name of the data block, a file type of the data block, a compression ratio of the data block, and other information about the data block.

22. The network component of claim 15, wherein the received one or more data blocks include one or more data objects each including a key, metadata, and data content.

23. In a storage system, a method for selective compression of data, the method comprising:
obtaining a plurality of data blocks for storage;
selecting at least some of the data blocks as candidates for compression according to at least one of attributes and content of the data blocks;
compressing the data blocks selected as candidates for compression;
storing the compressed data blocks; and
storing without compression any remaining data blocks that are not selected as candidates for compression.

24. The storage system of claim 23, wherein the data blocks selected as candidates for compression are compressed upon storing the data blocks.

25. The storage system of claim 23, wherein the data blocks selected as candidates for compression are compressed during a background process after storing the data blocks.

26. The storage system of claim 23, wherein the attributes include at least one of a name of the data block, a file type of the data block, a compression ratio of the data block, and other information in or about the data block.
